(19) United States
(12) Patent Application Publication
(10) Pub. No.: US 2004/0212164 A1
(43) Pub. Date: Oct. 28, 2004

(54) Modularized wheel chairs

(76) Inventors: Zen-Jye Chen, Taichung (TW); Hsiang-Suen Lin, Taichung (TW); Wen-Huei Chung, Taichung (TW); Shsu-Tung Chu, Taichung (TW); Chi-Ming Shih, Taichung (TW); Ju-Pin Li, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/845,173

(22) Filed: May 14, 2004

Related U.S. Application Data
(63) Continuation-in-part of application No. 10/205,467, filed on Jul. 26, 2002.

(51) Int. Cl. B62B 7/00

(52) U.S. Cl. 280/47.38

(57) ABSTRACT

A modularized wheel chair includes two front side members and two rear side members. Two top tubes and two down tubes are respectively connected between the front and rear side members. Each of the front side members has a plurality of front positioning holes that the front wheels unit is optionally connected to desired front positioning holes between the two front side members. Each of the rear side members has a plurality of rear positioning holes that the rear wheels unit is optionally connected to desired rear positioning holes between the two front side members. The position of the front wheels unit and the rear wheels unit can be installed at desired positions so as to obtain different sizes of the wheel chairs.

This a Continuation-In-Part application of applicant's former patent application Ser. No. 10/205,467, filed on Jul. 26, 2002.

### FIELD OF THE INVENTION

### Background of the Invention

A conventional wheel chair is made by connecting aluminum or metal tubes by way of welding or soldering, or simply by screwing them together. A front wheels unit, a rear wheel unit, a seat, two handles, and a foot rest are respectively connected to the frame composed of the metal tubes. In order to obtain a stable operational structure, the center of weight of the user has to be located between the front and rear wheel units. Nevertheless, if the wheel chair is operated by another person who holds the handles and moves the wheel chair, the rear wheel unit can be installed a distance from the user in the seat. On the contrary, if the user has to operate the wheel chair by himself or herself by using hands to rotate the rear wheels, the distance between the user and the rear wheels is expected to be as close as possible. By this arrangement, the user's hands need not to extend backward to reach the rear wheels. The two different requirements result difficulties for the manufacturers because a lot of parts of different sizes have to be made and stored in stock in order to meet different needs from the customers.

Some related inventions known to the applicant include U.S. Pat. Nos. 4,648,619, 4,721,321, 5,290,055, 5,328,183, 5,419,571, 5,516,226, 6,296,265, 6,338,496, 6,345,833, 6,394,476, 6,499,756, 6,499,762, 6,648,359, and British Patent GB2101540. German Patent DE 3742547, 4648619, and 328183 disclose an extra member for connecting the rear wheels. Some of the references includes holes defined in the tubes of the frame of the wheel chair and these holes weaken the structural strength of the frame.

The present invention intends to provide a modularized wheel chair wherein tubes, handles, and front and rear wheels can be connected between the modularized members at desired positions so as to reduce the number of parts to be manufactured and to meet different requirements of users.

### SUMMARY OF THE INVENTION

The present invention relates to a modularized wheel chair that comprises two front side members each having a first front connection tube, a second front connection tube and a plurality of front positioning holes. Two rear side members each have a first rear connection tube, a second rear connection tube and a plurality of rear positioning hole. Two top tubes are respectively connected between the two first front connection tubes of the two front side members and the two first rear connection tube of the two rear side members. Two down tubes are respectively connected between the two second front connection tubes of the two front side members and the two first rear connection tubes of the two rear side members. A front wheels unit having two front wheels is connected between two respective front positioning holes of the two front side member. A rear wheels unit having two rear wheels is connected between two respective rear positioning holes of the two rear side member.

The main object of the present invention is to provide a wheel chair that uses modularized members connected to be a frame of the wheel chair and each modularized member includes a plurality of holes such that the front and rear wheels units can be installed at desired positions according to the needs of the users.

The other object of the present invention is to provide a wheel chair that uses modularized members so as to reduce the stock pressure and less number of parts needs to be manufactured individually.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show the first embodiment of the wheel chair of the present invention;

FIG. 2 shows the front side member of the wheel chair of the present invention;

FIG. 3 shows the rear side member of the wheel chair of the present invention;

FIG. 4 shows the rear wheels unit is installed close to the user;

FIG. 5 shows that the handles can be installed at different angles;

FIG. 6 shows another embodiment of the wheel chair of the present invention, and

FIGS. 7 and 8 show two different embodiments of the rear side member.

### DETAILED DESCRIPTION OF THE PREFERRED EMBODIMENT

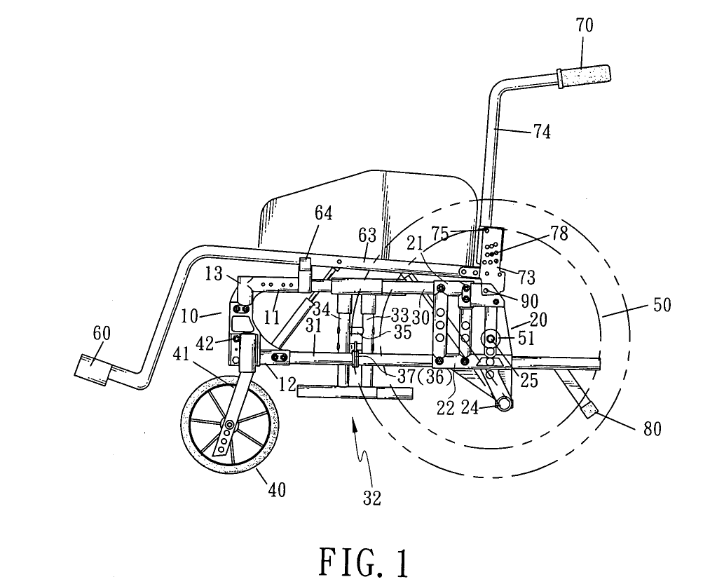

Referring to FIGS. 1 to 3, the modularized wheel chair of the present invention comprises two front side members 10 and two rear side members 20 which are connected to the front side members 10 by top tubes 30 and down tubes 31 to form a frame of the wheel chair.

Each of the front side members 10 includes a first front connection tube 11, a second front connection tube 12 located in below the first front connection tube 11, a front top connection hole 13, and a plurality of front positioning holes 14 defined through the front side member 10. Each of the two rear side members 20 includes a first rear connection tube 21, a second rear connection tube 22 located below the first rear connection tube 21, a rear top connection hole 23, a lateral connection hole 24 which is located below the second rear connection tube 22, and a plurality of rear positioning hole 25 defined through the rear side member 20.

Two top tubes 30 are respectively connected between the two first front connection tubes 11 of the two front side members 10 and the two first rear connection tube 21 of the two rear side members 20, and two down tubes 31 are respectively connected between the two second front connection tubes 12 of the two front side members 10 and the two first rear connection tubes 21 of the two rear side members 20. Each of the top tubes 30 is fixed in position by extending screws through one of positioning holes 15 defined through a wall of each of the first front connection tubes 11 and the positioning hole 26 defined through a wall of each of the first rear connection tubes 21, and contacting the top tube 30. Similarly, each of the down tubes 31 is fixed in position by extending screws through one of positioning holes 16 defined through a wall of each of the second front connection tubes 12 and one of the positioning holes 27 defined through a wall of the second rear connection tube 22 of the rear side members 20, and contacting the down tube 31. A transverse unit 32 is connected between the top tubes 30 and the down tubes 31. The transverse unit 32 includes two crossly connected tubes 33, 34 which are connected with each other by a connection pin 35, and connected between the two top tubes 30. Two connecting tubes 36, 37 are pivotably connected to the two crossly connected tubes 33, 34 and connected between the two down tubes 31. The transverse unit 32 allows the frame of the wheel chair to be folded by moving the two sides thereof toward each other so as to reduce the space occupied.

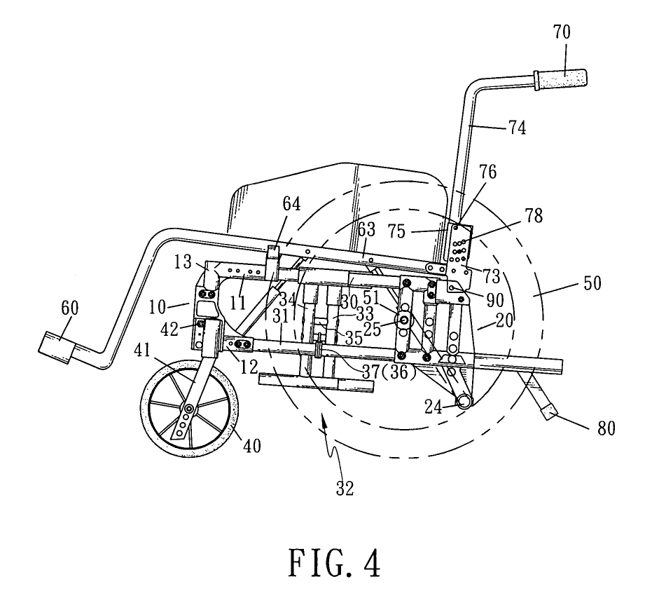

A front wheels unit has two front wheels 40 connected with two front wheel stays 41 which are fixed to one of the front positioning holes 14 of the two front side member 10 by securing members 42 according to practical needs. A rear wheels unit has two rear wheels 50 between which a shaft 51 is connected which extends through one of the rear positioning holes 25 of the two rear side member 20 according to practical needs. By choosing the positions of the front positioning holes 14 and the rear positioning holes 25, the wheel chair may have the front wheels 40 and the rear wheels 50 at different heights and distances so as to meet the users' needs. As shown in FIG. 4, the rear wheel 60 is located close to the front wheel 40 when compared with the position in FIG. 1.

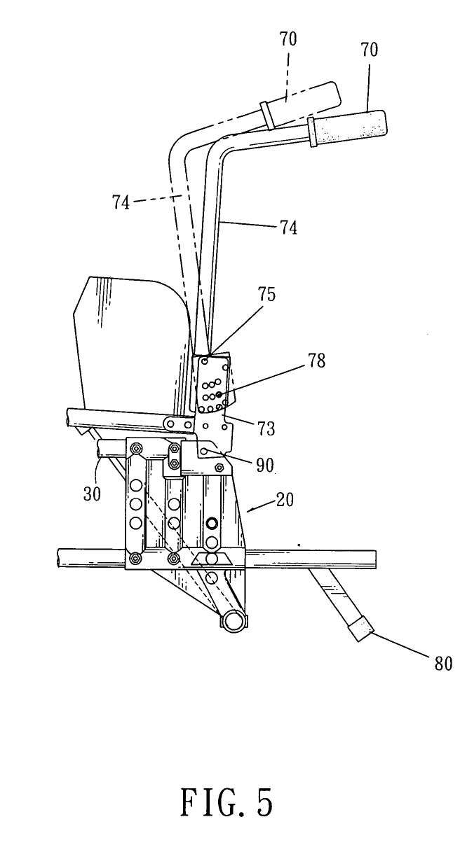

Each of the rear side members 20 has two connection holes 90 and a handle unit is connected to the desired one of the connection holes 90. The handle unit includes a base 73 pivotably connected to the connection hole 90 and an extension tube 74 which is connected to the base 73 and includes a grip 70 at a top end thereof. A block 75 is connected to a lower end of the extension tube 74 and a top end of the block 75 is pivotably connected to a top of the base 73 by a pin 76, and a lower end of the block 75 is optionally connected to one of holes 78 defined in the base 73 by a pin 77. Further referring to FIG. 5, the different holes 78 make the block 75 to be set at a specific angle relative to the frame and that is convenient for the person moving the wheel chair by operating the handle unit. A lug 79 extends from the base 73 and is connected to a tube 63 which has a foot rest 60 at a distal end thereof. A piece 64 fixed on the top tube 30 can be used to raise the tube 63 so that the foot rest 60 is oriented such that the user comfortably rests his or her feet on the foot rest 60. A stand 80 is optionally connected to the lateral connection hole 24 and positioned by a screw extending through one of the positioning holes 29.

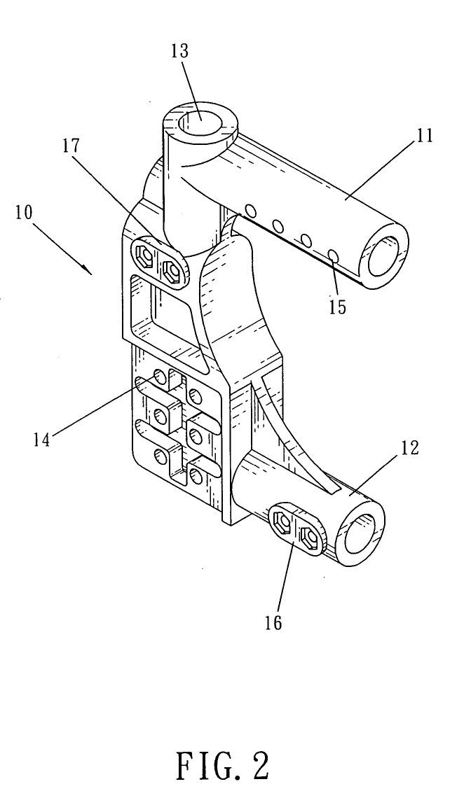

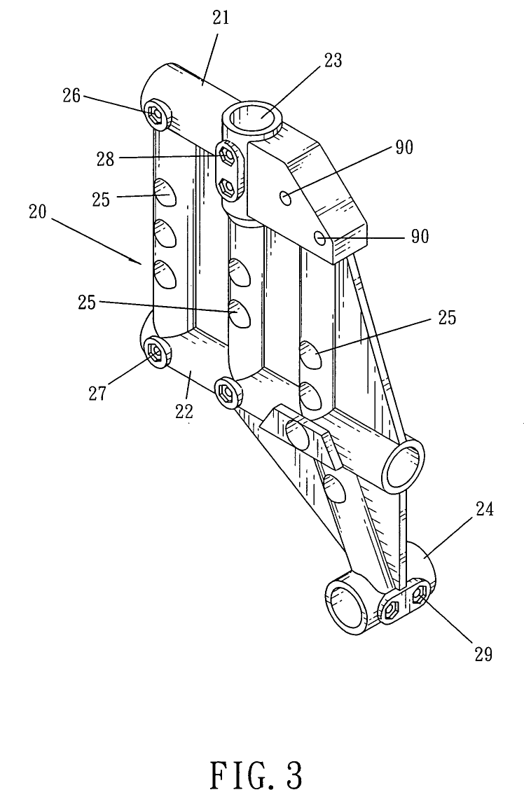

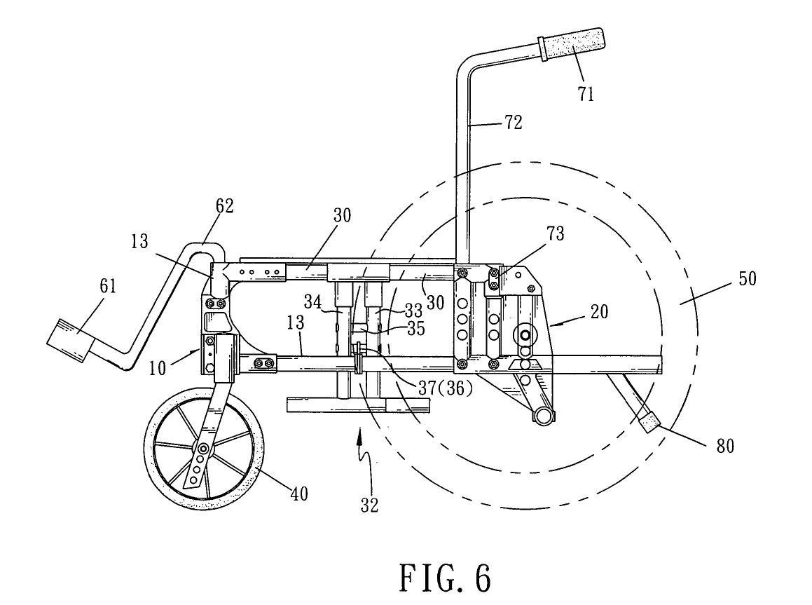

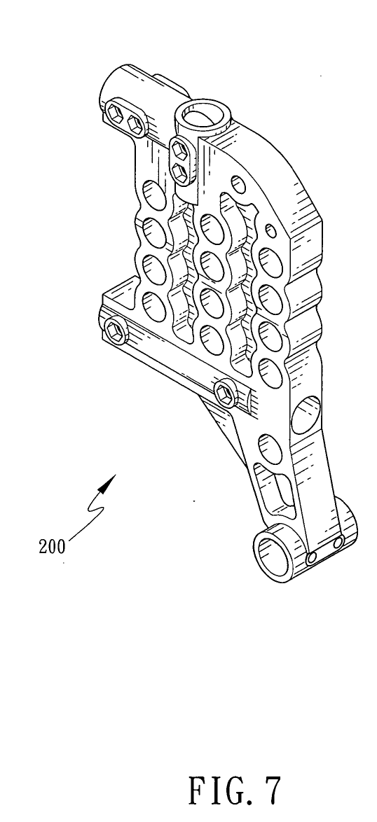

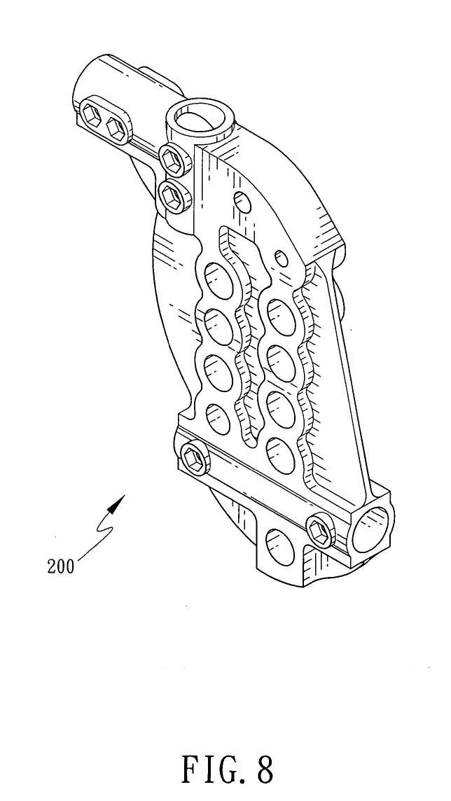

Referring to FIG. 6, the wheel chair can be simplified to include less number of parts wherein a tube 62 that is connected to the foot rest 61 can be directly inserted into the front top connection hole 13 and be positioned by extending a screw through one of the positioning holes 17 (FIG. 2). The handle unit including a tube 72 and a grip 71 can be directly inserted into the rear top connection hole 23 in each of the rear side members 20 and be positioned by extending a screw through one of the positioning holes 28 (FIG. 3). The length of the top tubes 30 and down tubes 31 can be chosen to meet the practical needs. FIGS. 7 and 8 show different embodiments of the rear side members 200.

By the modularized wheel chair, manufacturers only prepare fewer parts which provide multiple options for meeting the requirements for different users and effectively reduces the costs required for the wheel chairs.

While we have shown and described the embodiment in accordance with the present invention, it should be clear to those skilled in the art that further embodiments may be made without departing from the scope of the present invention.

What is claimed is:

1. A modularized wheel chair comprising:
two front side members (10) each having a first front connection tube (11), a second front connection tube (12) and a plurality of front positioning holes (14);
two rear side members (20) each having a first rear connection tube (21), a second rear connection tube (22) and a plurality of rear positioning hole (25), and
two top tubes (30) respectively connected between the two first front connection tubes (11) of the two front side members (10) and the two first rear connection tube (21) of the two rear side members (20), two down tubes (31) respectively connected between the two second front connection tubes (12) of the two front side members (10) and the two first rear connection tubes (21) of the two rear side members (20), a front wheels unit having two front wheels (40) and connected between two respective front positioning holes (14) of the two front side member (10), a rear wheels unit having two rear wheels (50) and connected between two respective rear positioning holes (25) of the two rear side member (20).

2. The wheel chair as claimed in claim 1, wherein each of the rear side members (20) has at least one connection hole (90) and a handle (74) is connected to the at least one connection hole (90).

3. The wheel chair as claimed in claim 1, wherein each of the rear side members (20) has a rear top connection hole (23) and a lateral connection hole (24) which is located below the second rear connection tube (22).
